(19) United States
(12) Patent Application Publication
(10) Pub. No.: US 2012/0324734 A1
(43) Pub. Date: Dec. 27, 2012

(54) ONE PIECE PUMP WITH HINGE

(76) Inventors: Andrew Anthony Szczepanowski, North Attleboro, MA (US); Vitaly Pesikov, Canton, MA (US)

(21) Appl. No.: 13/168,239

(22) Filed: Jun. 24, 2011

(51) Int. Cl. B26B 21/44; B29C 65/70; G01F 11/08

(52) U.S. Cl. 30/41; 222/324; 222/441; 264/241

(57) ABSTRACT

This invention relates to a novel one-piece pump or fluid dispensing apparatus having at least one hinge. The hinge allows for a streamlined manufacturing process which provides increased cost effectiveness. In addition, the hinge serves to orient or align the pump elements for easy, economical assembly of the finished device. The hinge may include one or more hinge elements or linkages.

### FIELD OF THE INVENTION

The apparatus relates generally to pumps for the dispensing of fluids which contain an integrated pump mechanism, and more particularly, to pumps for consumer products, such as razors.

### BACKGROUND OF THE INVENTION

Pumps for dispensing fluids can be integrated into a variety of consumer devices. Fluids can be dispensed in increments when the user engages the integrated pump components through compression of a button on the device with a finger or thumb. As shown in FIG. 1, these prior art pumps 10 are generally assembled from individual components 12, 14, 16, and 18 which may undesirably complicate assembly and increase the expense of manufacturing these pumps. Generally, to manufacture a prior art pump 10, each component 12, 14, 16, 18 must be formed separately; that is, a dedicated mold for each component. In addition, the individual components require manual assembly, increasing production time, as well as the cost of the integrated pumps. Further, assembly has an added complexity in that each individual component 12, 14, 16, 18 must be correctly aligned, with respect to each other component, by hand for proper operation of the pump.

### SUMMARY OF THE INVENTION

In a first implementation, a fluid dispensing apparatus includes a one piece body having a first element and a second element and at least one hinge integrally connecting the first element to the second element.

One or more of the following features may be included. The at least one hinge of the fluid dispensing apparatus may align the first element and the second element, bend to allow the second element to lie on top of the first element. The at least one hinge may include one or more hinge elements. When closed upon each other, the first and second elements are sealed together. The least one hinge is made of a rigid plastic, a flexible plastic, or any combination thereof.

In addition, the first and second elements are made of rigid plastic, a flexible plastic, or any combination thereof.

The first element may include an input channel, an input valve opening, a metering chamber, an output valve opening, an output channel, or any combination thereof and the second element comprises a compression button, an input valve, and an output valve, or any combination thereof. The compression button forms a metering chamber for holding a fluid, may be made of an elastomeric material, may have a dome-like structure, and may further include an integrally formed input valve and an integrally formed output valve. The input and output valves may be flap valves. The compression button, when depressed by a user, dispenses fluid out of the output channel.

One or more of the following features may be included. The first element may be encompassed within a handle neck, a handle with a reservoir, or any combination thereof. The reservoir may include a fluid.

The fluid dispensing apparatus is disposed in a personal care product, a home care product, a beauty care product, a health care product, or a pet care product. The personal care product could be a razor and the handle could be a razor handle.

In yet another implementation, a method of making a one piece fluid dispensing apparatus includes providing a mold designed to shape a first element, a second element and at least one hinge, forming the first element, the second element and the one or more hinges using an injection molding process, aligning the first element and the second element using the hinge, and sealing the dispensing apparatus.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is an exploded view of a prior art pump.

FIG. 2A is a view of the one piece pump with hinge in the open position in accordance with the present invention.

FIG. 2B is a perspective top view of the one piece pump with hinge in a partially closed position in accordance with the present invention.

FIG. 2C is a perspective top view of the one piece pump with hinge in the closed position in accordance with the present invention.

FIG. 2D is a cross-sectional view of the one piece pump with hinge in the closed position in accordance with the present invention.

FIG. 3A is a perspective top view of the one piece pump in the open position contained within a handle neck in accordance with an alternate embodiment of the present invention.

FIG. 3B is a perspective top view of the one piece pump in the closed position contained within a handle neck in accordance with an alternate embodiment of the present invention.

FIG. 3C is a cross-sectional view of the one piece pump in the closed position contained within a handle neck in accordance with an alternate embodiment of the present invention.

FIG. 4A is a perspective view of the one piece pump within a razor handle in the open position in accordance with another alternate embodiment of the present invention.

FIG. 4B is a perspective view of the one piece pump contained within a razor handle in the closed position in accordance with another alternate embodiment of the present invention.

FIG. 5 is a top view of the one piece pump with hinge having hinge elements in an open position in accordance with yet another alternate embodiment of the present invention.

FIG. 6 is a top view of the one piece pump with two hinges each having hinge elements in accordance with still yet another alternate embodiment of the present invention.

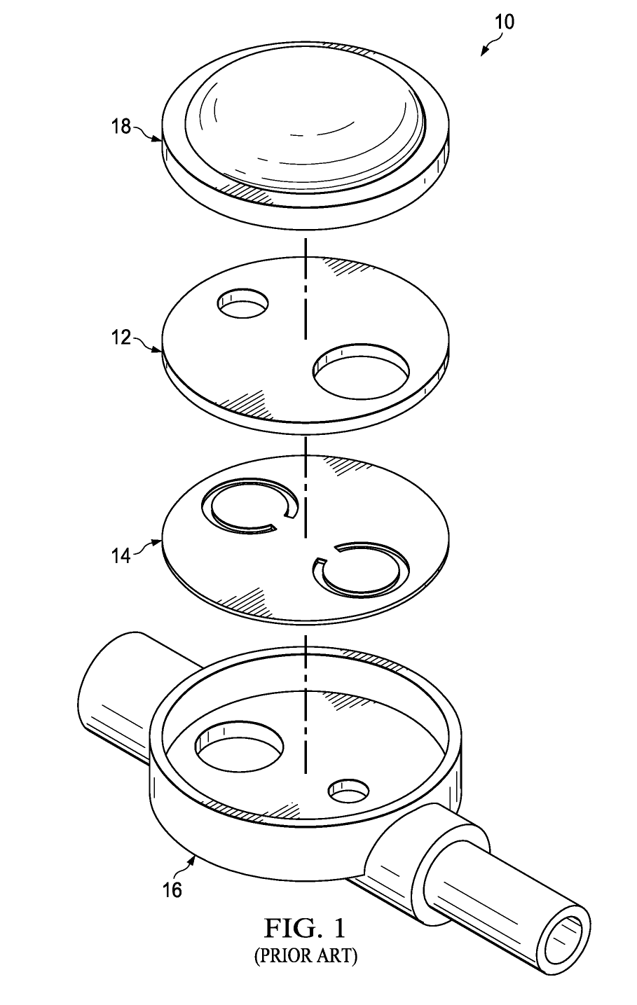

### DETAILED DESCRIPTION OF THE INVENTION

This invention relates to a novel one-piece pump having at least one hinge. The hinge allows for a streamlined manufacturing process which provides increased cost effectiveness. In addition, the hinge serves to orient the pump elements for easy, economical assembly of the finished device.

The terms “pump” and “fluid dispensing apparatus” are used herein interchangeably. The term “one-piece” signifies that the pump components are initially interconnected or coupled together.

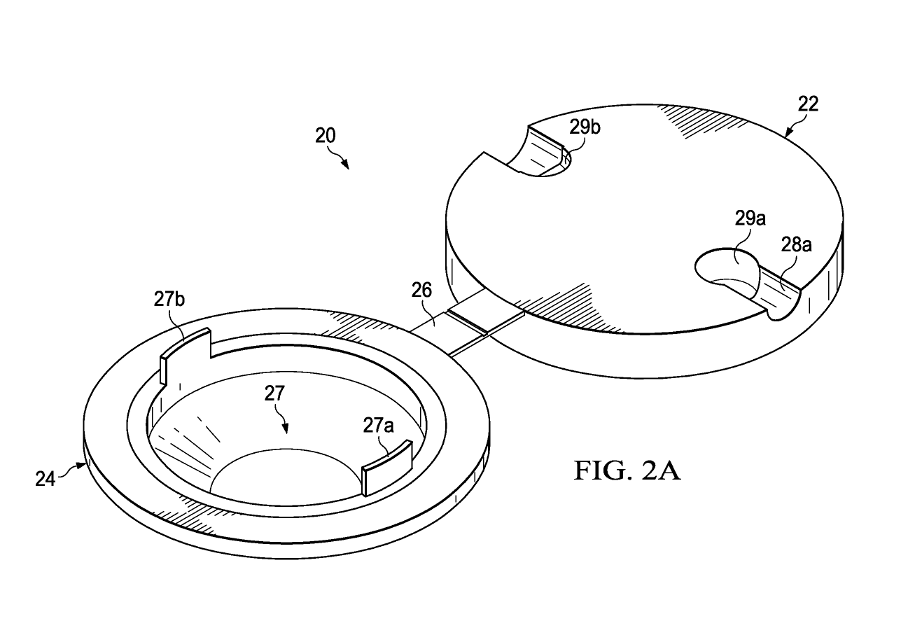

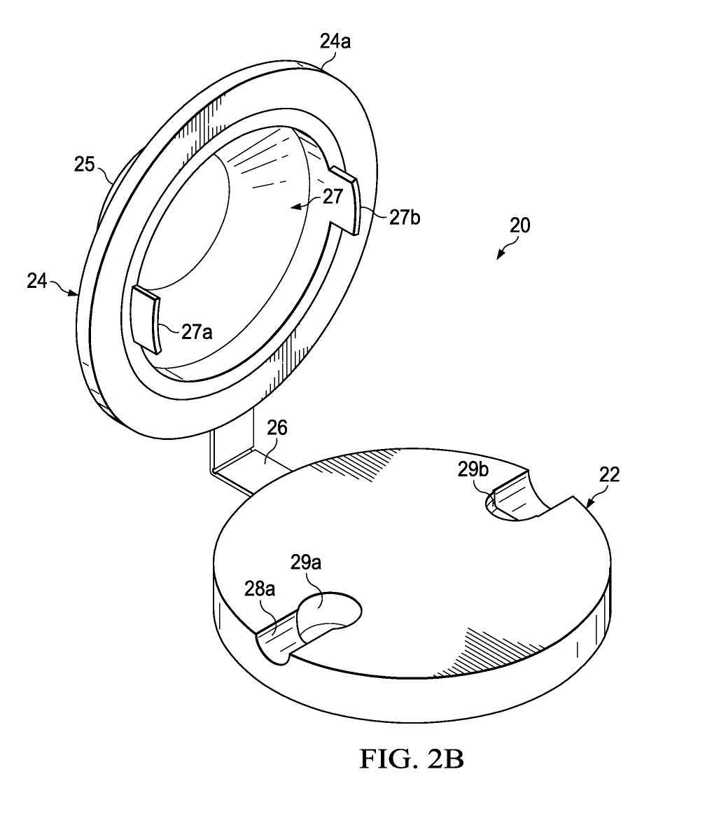

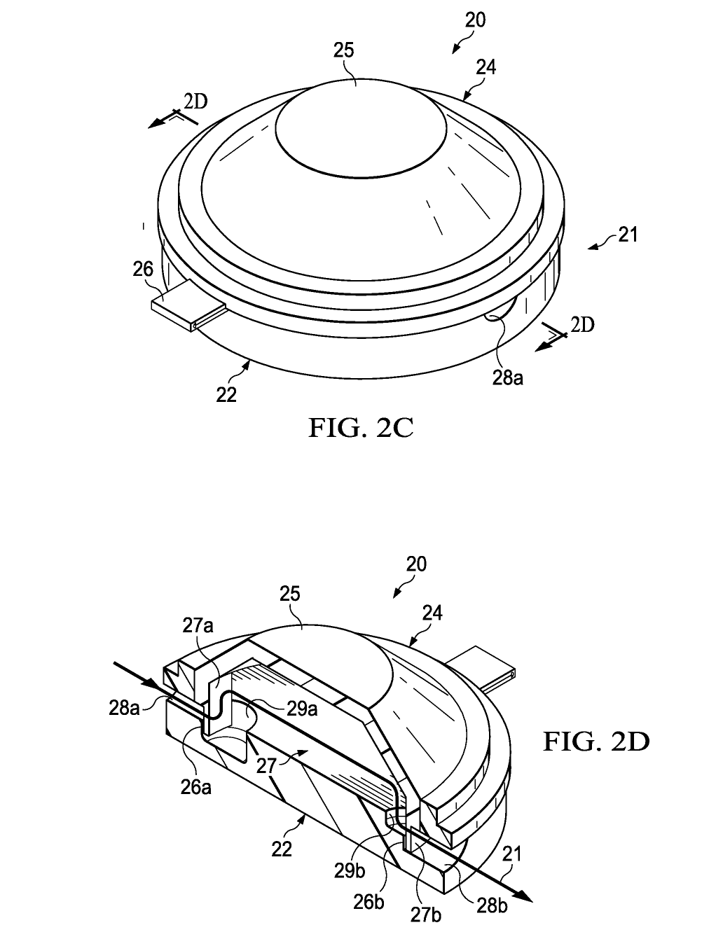

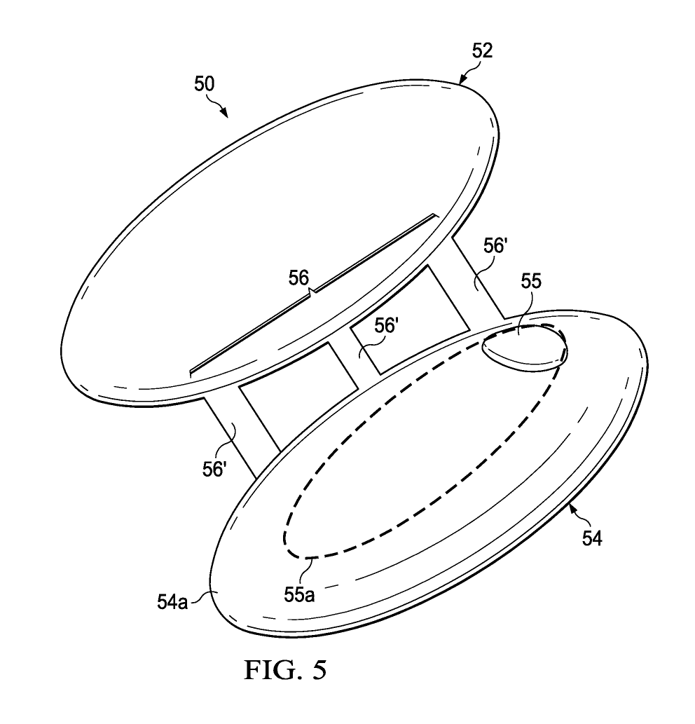

As seen in FIGS. 2A, 2B, 2C, and 2D, a first embodiment of a one piece pump 21 of the present invention is shown having a body 20 including a first element 22, a second element 24, and a hinge 26. The hinge 26 connects the first element 22 and the second element 24 forming a one-piece body 20. As shown, the hinge 26 preferably provides a single contiguous linkage between the first element and the second element, though it may be desirable for the hinge 26 to include one or more linkage (e.g., a set of linkages), as will be discussed below with regard to FIG. 5. The hinge may be formed of elastomeric materials or of rigid plastics or any combination thereof and may be a living hinge which is generally integrated or coupled with a component. In general terms, the hinge may be thought to operate much like any door hinge would, in that it assists a door (likened to the second element) to close over the door opening (likened to the first element).

Having a hinge 26 not only reduces assembly costs and time, but also provides an unexpected ability to align the first element 22 with the second element. In turn, this ability eliminates the risk of misalignment of the elements, and the need for time-consuming, painstaking hand assembly of multiple, individual components.

FIG. 2A shows the body 20 in an open position. As shown, the body 20 preferably has a round shape, but any shape is contemplated in the present invention as will be discussed below. The first element 22 is shown containing an input valve opening 29a, an input valve channel 28a and an output valve opening 29b. These pump components will form part of the fluid path 21 once the apparatus 20 is fully formed, as shown in FIG. 2D.

The first element 22 may be formed from a variety of plastics. Examples include polyethylene, polypropylene, polyurethane or elastomeric materials, but other plastics may be suitable for the formation of the first element 22.

The second element 24 may preferably be a dome-like structure as depicted in FIGS. 2A, 2B, 2C, and 2D comprised of a flexible plastic, such as an elastomeric material. The second element 24 may be formed from flexible plastic materials including elastomers and thermoplastic elastomers. Kraton is an example of a commercially available elastomer suitable for forming the second element 24. The second element 24 may comprise an input valve 27a and an output valve 27b. In this embodiment, the input valve 27a and output valve 27b are shown as flap valves, but any suitable valves are contemplated in the present invention, such as, by way of non-limiting examples, slit valves, duck bill valves, or other valves known in the art.

FIG. 2B shows body 20 in a partially closed position as the hinge 26 is bent or folded over. The advantages of the using a hinge for alignment and streamlined assembly are apparent, as one can see that the hinge 26 positions the input valve 27a and output valve 27b for precise alignment with the input valve opening 29a and the output valve opening 29b for proper operation of the pump.

FIG. 2C shows the body 20 in a closed position after the hinge 26 has been engaged, aligning the first element 22 and the second element 24 and allowing the elements to lie, or close on top of each other. In lay terms, this can be likened to a box or a clam shell closing. The first 22 and second 24 elements are desirably sealed around their perimeters 21. Suitable means of sealing the body 20 at perimeter 21 in its closed position include, but are not limited to, adhesives, heat sealing, chemical sealing, or sealing by mechanical means such as grooves, slots or tabs that allow the first element 22 and the second element 24 to securably connect. When the body 20 is sealed, a chamber 27 is formed which may be referred to as a metering chamber in that it meters out a fluid filled therein. The dome-like second element 24 forms a type of compression button 25 which is an integral part of the second element 24 and serves to dispense fluid when the user depresses the compression button 25 (typically with a finger).

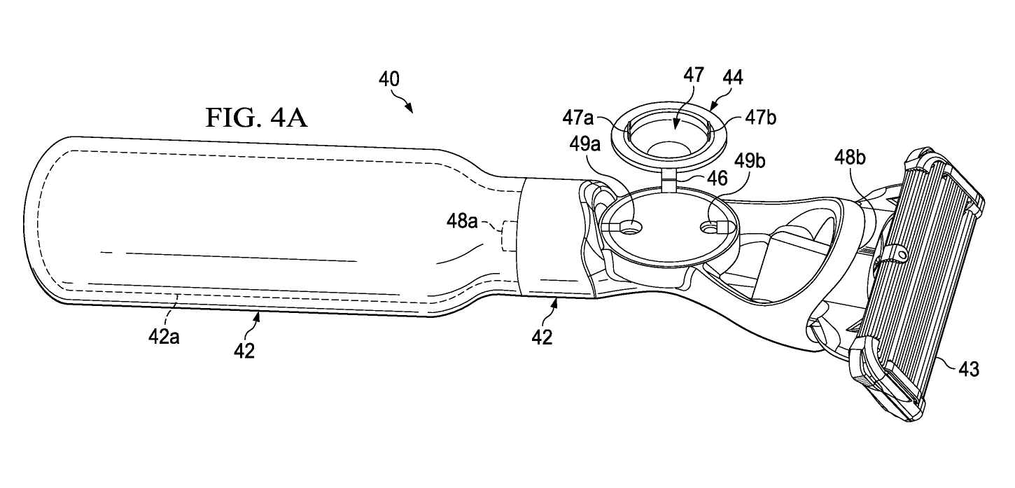

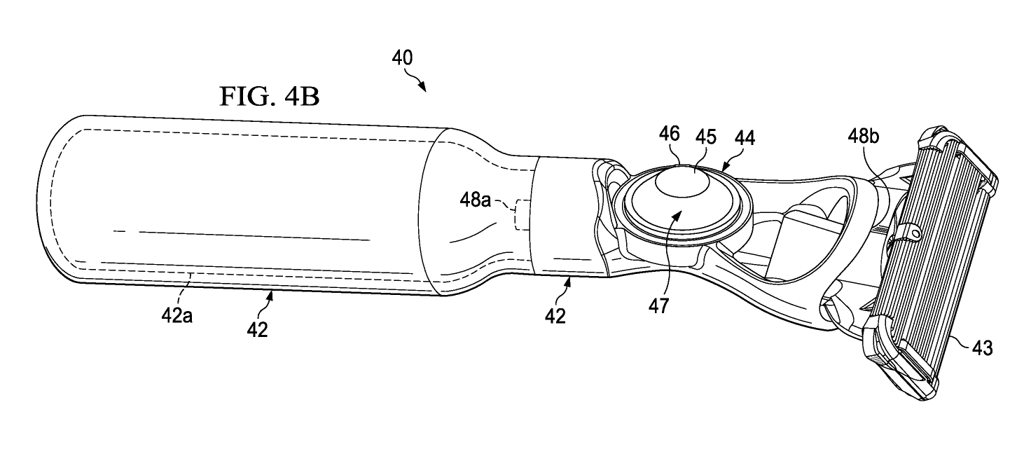

Once sealed, the first element 22 and second element 24 may operate as a functional integrated pump mechanism as illustrated in FIG. 2D. After the chamber 27 within the body 20 is primed and filled with a fluid (not shown), which may be delivered from an attached reservoir 42a such as a pouch or cavity (e.g., as shown in FIG. 4B), the apparatus will operate to dispense fluid, following path 21. When the user depresses the compression button 25, fluid is forced from the metering chamber 27, flowing into output valve opening 29b and displacing output valve 27b. Fluid flows through output channel 28b to the user. When the compression button 25 returns to its original position, output valve 27b returns to its closed position. Valve stop 26b, shown in FIG. 2D, which is integrally formed as a part of the first element 22, prevents the output valve from moving into the output valve opening 29b and seals the metering chamber 27. A fresh charge of fluid will displace the input valve 27a and fluid will flow into the metering chamber 27. Input valve stop 26a prevents the input valve 27a from being displaced into the input channel 28a and seals the metering chamber 27 once it is charged with fresh fluid.

Desirably, pump body 20 may be made from a single mold, eliminating the need for discrete or dedicated molds of the prior art, reducing manufacturing costs. Depending on the intended embodiment, a one-, two-, or three color injection molding process can be used to manufacture all pump components within a single mold. If fluid dispensing body 20 will be manufactured from entirely elastomeric materials, a one color injection molding process can be used. For example, the body 20 may be molded from a polyolefin elastomer (such as DOW ENGAGE). In this way, a balance between the stiffness of a thermoplastic and the softness of a thermoplastic elastomer may be provided thereby producing the elements of a functional integrated pump mechanism, along with hinge 26, in a single step. This in turn, allows for a streamlined assembly where costs are further reduced through the use of the hinge 26 as discussed above.

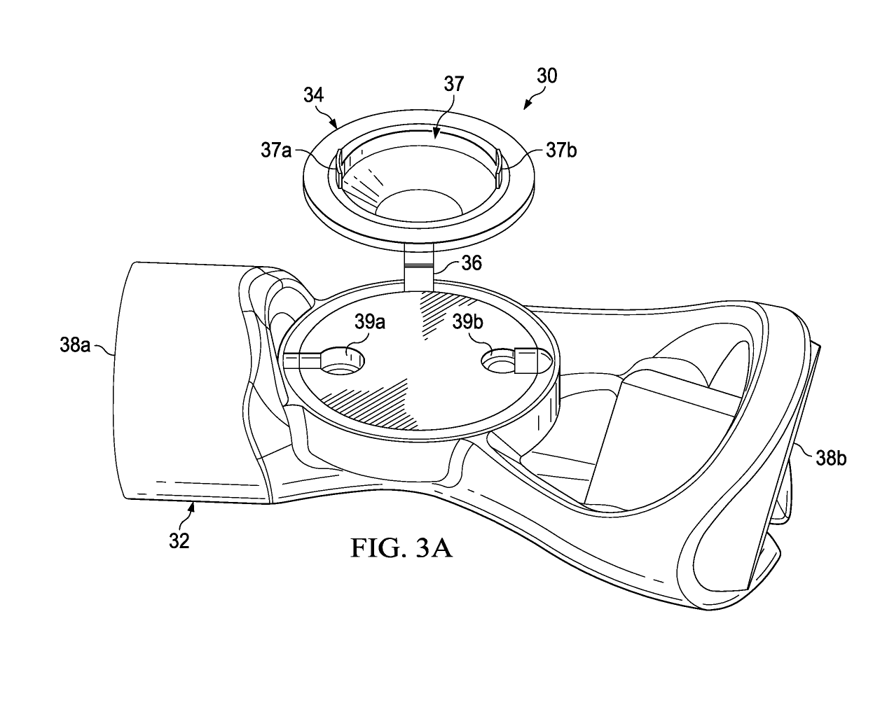

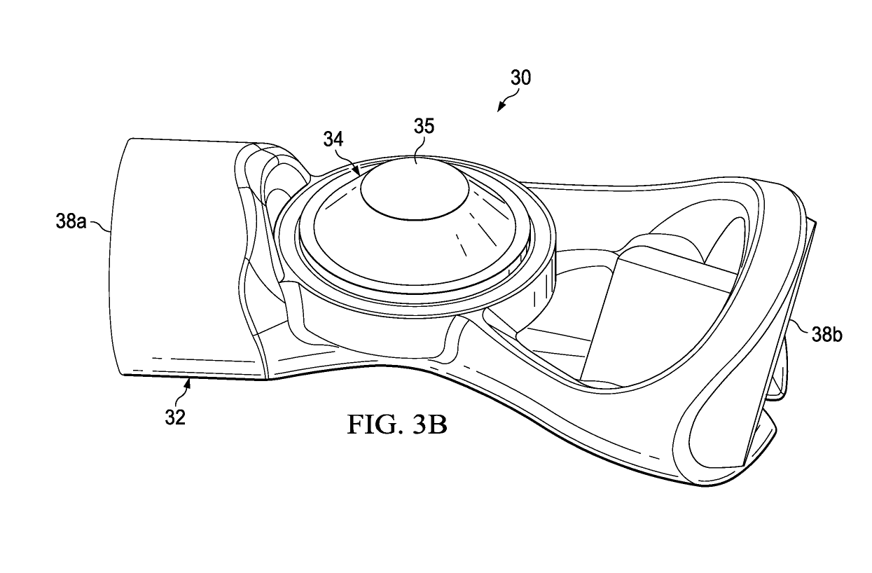

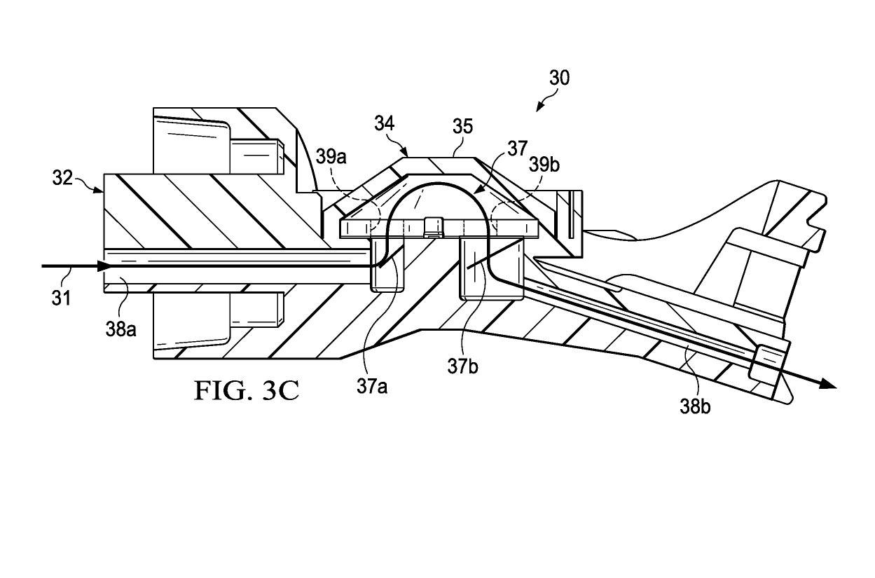

In an alternate embodiment of the present invention, shown in FIGS. 3A, 3B, and 3C a one piece pump embodied within a handle neck 30 is illustrated. The handle neck 30 may be coupled to a handle in any consumer type product where fluid dispensing is desired via a pump, such as a razor or toothbrush. The one piece pump may be of similar type as the pump described above with regard to FIGS. 2A through 2D, but the first element of the pump may be modified to be formed as part of the handle neck. Referring to FIGS. 3A, 3B, and 3C, the first element comprises an input channel 38a which carries fluid to the input valve opening 39a, and an output valve opening 39b which directs fluid to the output channel 38b. The second element 34 is comprised of an integrally formed input valve 37a and an integrally formed output valve 37b, and is shaped such that it forms a metering chamber 37 and a compression button 35 to enable operation of the pump when assembled with the first element 32. The first element 32 is integrally connected to the second element 34 by a hinge 36. The hinge 36 is formed such that it aligns the second element 34 with the first element 32 for assembly.

FIG. 3B illustrates the body 30 in its closed position where engaging the hinge 36 forms a functional pump mechanism. FIG. 3C is a cross-sectional view of the second embodiment of the one piece dispensing apparatus shown in FIG. 3B depicting the fluid path 31.

FIG. 4A illustrates body 40 in the open position with the first element 42 taking the form of a razor handle in still another embodiment of the present invention. As mentioned above, the body 40 may be connected to a suitable, fluid filled reservoir 42a such as a cavity or a pouch. The use of a hinge 46 allows body 40 to be molded from a single mold, even when the body 40 is comprised of more than one type of material.

For example, if the body 40 were made of two different materials, a two color injection molding process may preferably be used. In this case, the first element 42 may be molded from polypropylene in the initial molding step. Then, in the second injection molding step, the flexible second element 44 and the hinge 46 may be molded from an elastomeric material, such as Kraton G (SEBS).

By way of non-limiting example, the first element 42 may also be molded from a single material such as polypropylene, while the second element 44 may be molded from two different materials in order to provide the desired shape and properties for the second element 44. In this case, the hinge 46 and a portion of the second element 44 may be molded from a rigid plastic material (such as polypropylene) during the initial injection molding step (or steps if multiple injection molding shots are needed to provide the desired shape). Thus in this example, only the compression button 45 would be molded from an elastomeric material such as Kraton G (SEBS) during the final injection molding step.

The embodiment of the present invention shown in FIG. 4A illustrates an input channel 48a which carries fluid to the input valve opening 49a, and an output valve opening 49b which directs fluid to the output channel 48b. FIG. 4A illustrates but one possible shape for the first element 42 which may take a variety of shapes. The second element 44 may also comprise an integrally formed input valve 47a and an integrally formed output valve 47b. The second element is shaped such that it forms a metering chamber 47 and a compression button 45 to enable operation of the pump when assembled with the first element 42.

FIG. 4B illustrates body 40 in the closed position where the first element 42 of FIG. 4A comprises a razor handle. The second element 44 is shown in its closed position after the hinge 46 has been engaged to create a metering chamber 47. In this embodiment, activation of the pump through depression of the compression button 45 conveniently dispenses fluid from a reservoir 42a to a razor head 43 during shaving.

Referring to FIG. 5 the body 50 is comprised of a first element 52 and a second element 54 connected by a hinge 56 in accordance with yet another embodiment of the present invention. This embodiment illustrates that the design of the body 50 may vary and take many shapes and that the location and configuration of the hinge 56 may also vary. In this example, the hinge 56 is comprised of a set of hinge elements 56′ or linkages which integrally connect the first element and the second element. In this way, a non-contiguous or intermittent type hinge is formed during manufacturing.

In addition, the second element 54 comprises a larger frame portion 54a as well as a compression button 55. The compression button 55 may vary in size, shape, or location for aesthetic reasons or for obtaining a better pump mechanism with differently shaped first and second elements. For example, compression button 55 may encompass a small portion of the second element 54, as shown by compression button 55, or alternatively encompass a large portion of the second element 54, as shown by compression button 55a (shown in dotted line). In either embodiment, the hinge 56 connects a first element 52 to a second element 54 and provides the benefits of a more economical manufacturing and assembly as discussed previously.

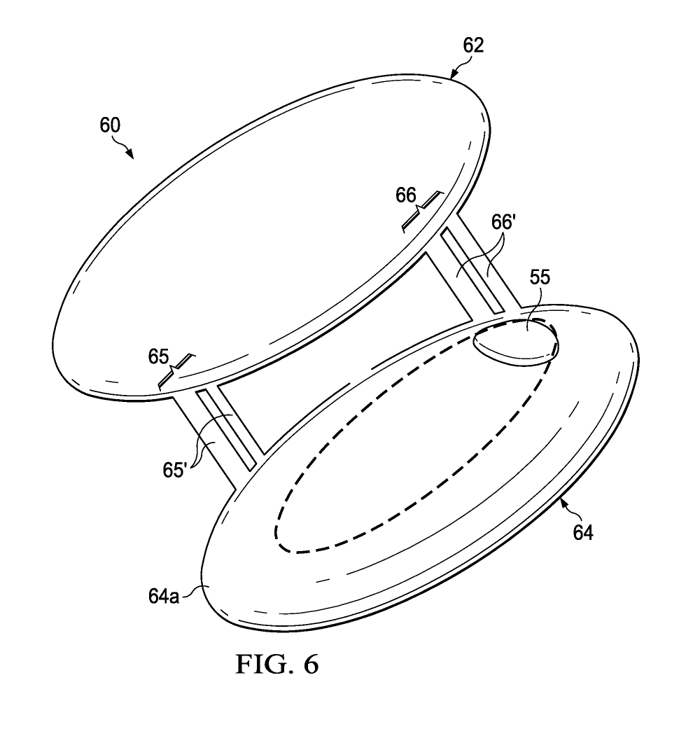

Referring now to FIG. 6, an alternate embodiment of the present invention is shown where pump body 60 includes two hinges 65 and 66, each having a set of hinge elements 65′ and 66′ respectively, where hinges 65 and 66 couple first and second elements 62 and 64.

It is desirable that the compression button 55, 55a be designed to spring back to its original, uncompressed position after every depression of the compression button 55, 55a by the user. Further optimization of the pump performance in this regard may be achieved by varying the thickness of different areas of the compression button 55, 55a. For example, referring to FIG. 2B, the side walls 24a of compression button 25 of element 24 may be molded to be slightly thicker and more resilient than the top portion of the button 25. Pump performance may also be optimized through other means, such as providing for ribs (not shown) on the interior of compression button 25.

The fluid dispensing apparatus or pump, as described above with regard to FIGS. 2 through 5, may be integrated into a consumer product where it is convenient to dispense fluid, potentially in metered increments, while the product is being used. Such products may include any type of personal care product such as a razor, home care product, beauty care product, health care product, pet care product, or within any other products where an economical, one piece dispensing apparatus is advantageous for dispensing fluids. Thus, the apparatus may dispense fluids including, but not limited to, shave gel, lotion, shampoo or conditioner, liquid soaps, pet care or other cleaning products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid dispensing apparatus comprising:
a one piece body having a first element and a second element and at least one hinge integrally connecting the first element to the second element.

2. The apparatus of claim 1 wherein the at least one hinge aligns the first element with the second element.

3. The apparatus of claim 1 wherein the at least one hinge bends to allow the second element to lie on top of the first element.

4. The apparatus of claim 1 wherein the at least one hinge further comprises one or more hinge elements.

5. The apparatus of claim 1 wherein the first and second elements are sealed together.

6. The apparatus of claim 1 wherein the at least one hinge is comprised of a rigid plastic, a flexible plastic, or any combination thereof.

7. The apparatus of claim 1 wherein the first and second elements are comprised of a rigid plastic, a flexible plastic, or any combination thereof.

8. The apparatus of claim 1 wherein the first element further comprises an input channel, an input valve opening, a metering chamber, an output valve opening, an output channel, or any combination thereof and the second element comprises a compression button, an input valve, and an output valve, or any combination thereof.

9. The apparatus of claim 8 wherein the compression button forms a metering chamber for holding a fluid.

10. The apparatus of claim 8 wherein the compression button comprises an elastomeric material.

11. The apparatus of claim 8 wherein the compression button further comprises a dome-like structure.

12. The apparatus of claim 8 wherein the compression button further comprises an integrally formed input valve and an integrally formed output valve.

13. The apparatus of claim 8 wherein the input valve is a flap valve and the output valve is a flap valve.

14. The apparatus of claim 8 wherein the compression button, when depressed by a user, dispenses fluid out of the output channel.

15. The apparatus of claim 1 wherein the first element is encompassed within a neck, a handle with a reservoir, or any combination thereof.

16. The apparatus of claim 15 wherein the reservoir contains fluid.

17. The apparatus of claim 1 wherein said fluid dispensing apparatus is disposed in a personal care product, a home care product, a beauty care product, a health care product, or a pet care product.

18. The apparatus of claim 17 wherein said personal care product is a razor.

19. The apparatus of claim 15 wherein the handle is a razor handle.

20. A method of making a one piece fluid dispensing apparatus comprising:
providing a mold designed to shape a first element, a second element and at least one hinge integrally connecting the first element to the second element;
forming the first element, the second element and the at least one hinge using an injection molding process;
aligning the first element and the second element using the at least one hinge; and
sealing the fluid dispensing apparatus.
